(19) United States
(12) Patent Application Publication
(10) Pub. No.: US 2025/0383734 A1
(43) Pub. Date: Dec. 18, 2025

(54) DISPLAY DEVICE AND METHOD FOR DRIVING THE SAME, AND ELECTRONIC DEVICE INCLUDING DISPLAY DEVICE

(71) Applicant: Samsung Display Co., Ltd., Yongin-si (KR)

(72) Inventors: Bong Il KANG, Yongin-si (KR); Sang Hyun LIM, Yongin-si (KR); Min Hong KIM, Yongin-si (KR); Sang Kook KIM, Yongin-si (KR)

(21) Appl. No.: 19/188,139

(22) Filed: Apr. 24, 2025

(30) Foreign Application Priority Data
Jun. 18, 2024 (KR) 10-2024-0079214
Jul. 8, 2024 (KR) 10-2024-0089636

(51) Int. Cl. G06F 3/041; G06F 3/044

(52) U.S. Cl. CPC G06F 3/04164; G06F 3/0446; G06F 2203/04111

(57) ABSTRACT

One or more embodiments provide a display device including a touch panel including first touch electrodes arranged in a first direction, and second touch electrodes arranged in a second direction crossing the first direction, and a touch panel driver configured to provide touch-driving signals to the first touch electrodes, and to receive touch-sensing signals corresponding to the touch-driving signals from the second touch electrodes, wherein the second touch electrodes and the first touch electrodes are configured to receive a same voltage in a non-touch section.

### CROSS-REFERENCE TO RELATED APPLICATION

The present application claims priority to, and the benefit of, Korean Patent Application No. 10-2024-0079214, filed on Jun. 18, 2024, in the Korean Intellectual Property Office, and 10-2024-0089636, filed on Jul. 8, 2024, in the Korean Intellectual Property Office, the entire disclosures of which are incorporated herein by reference.

### BACKGROUND

### 1. Field

The present disclosure relates to a display device including a touch panel and a method for driving the same.

### 2. Description of the Related Art

Electronic devices equipped with a touch panel and having a function of indicating a position by touch are widely used. For example, touch panels are widely used with the spread of mobile electronic devices such as smartphones or tablet computers.

To test the reliability of the touch panel, the touch panel may be exposed to a high temperature and/or high humidity environment. Such reliability tests may accelerate the corrosion of the touch electrodes of the touch panel.

### SUMMARY

One aspect of the present disclosure provides a display device that reduces the corrosion rate of the touch electrodes.

Another aspect of the present disclosure provides a method for driving a display device.

To achieve one aspect of the present disclosure, one or more embodiments provides a display device including a touch panel including first touch electrodes arranged in a first direction, and second touch electrodes arranged in a second direction crossing the first direction, and a touch panel driver configured to provide touch-driving signals to the first touch electrodes, and to receive touch-sensing signals corresponding to the touch-driving signals from the second touch electrodes, wherein the second touch electrodes and the first touch electrodes are configured to receive a same voltage in a non-touch section.

The touch panel driver may be configured to operate in a first mode when an amount of change in capacitance between the first touch electrodes and the second touch electrodes is less than a reference amount of change, to operate in a second mode when the amount of the change in the capacitance is equal to or greater than the reference amount of the change, and to apply the same voltage to the second touch electrodes and to the first touch electrodes in the non-touch section of the second mode.

The touch panel driver may be configured to apply a reference voltage to the second touch electrodes in the touch section of the second mode and in the first mode.

The first touch electrodes may be configured to receive a ground voltage in the non-touch section.

The touch panel driver may include a signal receiver, the signal receiver including an amplifier including a first input terminal, a second input terminal, and an output terminal connected to at least one of the second touch electrodes, a first switch including a first terminal connected to the first input terminal of the amplifier, and a second terminal connected to the output terminal of the amplifier, and a capacitor including a first electrode connected to the first input terminal of the amplifier, and a second electrode connected to the output terminal of the amplifier, wherein the second input terminal of the amplifier is configured to selectively receive one of the ground voltage or the reference voltage.

The touch panel driver may be configured to apply the ground voltage to the second input terminal of the amplifier in the non-touch section of the second mode, and to apply the reference voltage to the second input terminal of the amplifier in the touch section of the second mode and in the first mode.

The touch panel driver may include a signal receiver, the signal receiver including an amplifier including a first input terminal, a second input terminal, and an output terminal connected to at least one of the second touch electrodes, or configured to receive the ground voltage, a first switch including a first terminal connected to the first input terminal of the amplifier, and a second terminal connected to the output terminal of the amplifier, and a capacitor including a first electrode connected to the first input terminal of the amplifier, and a second electrode connected to the output terminal of the amplifier.

The touch panel driver may be configured to apply the ground voltage to the first input terminal of the amplifier in the non-touch section of the second mode, and to connect the first input terminal of the amplifier to the at least one of the second touch electrodes in the touch section of the second mode and in the first mode.

The touch panel driver may be configured to apply a reference voltage to the second touch electrodes and to the first touch electrodes in the non-touch section of the second mode.

To achieve one aspect of the present disclosure, one or more embodiments provides a method for driving a display device, the method including detecting an amount of change in capacitance between first touch electrodes and second touch electrodes, and applying a same voltage to the second touch electrodes and to the first touch electrodes in a non-touch section when the amount of the change in the capacitance is equal to or greater than a reference amount of change.

The method may further include applying a reference voltage to the second touch electrodes in the touch section when the amount of the change in the capacitance is equal to or greater than the reference amount of the change, and applying the reference voltage to the second touch electrodes when the amount of the change in the capacitance is less than the reference amount of the change.

The method may further include applying a ground voltage to the first touch electrodes in the non-touch section.

At least one of the second touch electrodes may be connected to a signal receiver, the signal receiver including an amplifier including a first input terminal, a second input terminal, and an output terminal connected to the at least one of the second touch electrodes, a first switch including a first terminal connected to the first input terminal of the amplifier, and a second terminal connected to the output terminal of the amplifier, and a capacitor including a first electrode connected to the first input terminal of the amplifier, and a second electrode connected to the output terminal of the amplifier, wherein the method further includes selectively applying one of the ground voltage or the reference voltage to the second input terminal of the amplifier.

The method may further include applying the ground voltage to the second input terminal of the amplifier in the non-touch section when the amount of the change of the capacitance is equal to or greater than the reference amount of the change, applying the reference voltage to the second input terminal of the amplifier in the touch section when the amount of the change of the capacitance is equal to or greater than the reference amount of the change, and applying the reference voltage to the second input terminal of the amplifier when the amount of the change of the capacitance is less than the reference amount of the change.

At least one of the second touch electrodes may be connected to a signal receiver, the signal receiver including an amplifier including a first input terminal, a second input terminal, and an output terminal connected to the at least one of the second touch electrodes, or configured to receive the ground voltage, a first switch including a first terminal connected to the first input terminal of the amplifier, and a second terminal connected to the output terminal of the amplifier, and a capacitor including a first electrode connected to the first input terminal of the amplifier, and a second electrode connected to the output terminal of the amplifier.

The method may further include applying the ground voltage to the first input terminal of the amplifier in the non-touch section, and connecting the first input terminal of the amplifier to the at least one of the second touch electrodes, in the touch section when the amount of the change in the capacitance is equal to or greater than the reference amount of the change, and connecting the first input terminal of the amplifier to the at least one of the second touch electrodes in the touch section when the amount of the change in the capacitance is less than the reference amount of the change.

The method may further include applying a reference voltage to the second touch electrodes, and applying the reference voltage to the first touch electrodes in the non-touch section when the amount of the change in the capacitance is equal to or greater than the reference amount of the change.

To achieve one aspect of the present disclosure, one or more embodiments provides an electronic device, the electronic device comprising a processor to provide input image data; and a display device to display an image based on the input image data, the display device comprising a touch panel comprising first touch electrodes arranged in a first direction, and second touch electrodes arranged in a second direction crossing the first direction; and a touch panel driver configured to provide touch-driving signals to the first touch electrodes, and to receive touch-sensing signals corresponding to the touch-driving signals from the second touch electrodes, wherein the second touch electrodes and the first touch electrodes are configured to receive a same voltage in a non-touch section.

According to the display device according to one or more embodiments of the present disclosure, there may be reduced or prevented the corrosion of the touch electrodes due to the ions of another layer reacting with the touch electrodes by applying the same voltage to the first touch electrodes and the second touch electrodes.

However, aspects of the present disclosure are not limited to the above-described aspects, and may be variously expanded within the scope that does not depart from the spirit and scope of the present disclosure.

### BRIEF DESCRIPTION OF THE DRAWINGS

FIG. 1 is a drawing illustrating a display device according to one or more embodiments of the present disclosure.

FIG. 2 is a cross-sectional view illustrating an example of the display device in FIG. 1.

FIG. 3 is a block diagram illustrating an example of a display panel and a display panel driver in FIG. 1.

FIG. 4 is a block diagram illustrating an example of the touch panel in FIG. 1.

FIG. 5 is a drawing for explaining the touch panel driver in FIG. 1.

FIG. 6 is a timing diagram illustrating an example of the touch panel driver in FIG. 5 driving the touch electrodes in a first mode.

FIG. 7 is a timing diagram illustrating an example of the touch panel driver in FIG. 5 driving the touch electrodes in a second mode.

FIG. 8 is a drawing for explaining the touch panel driver of the display device according to one or more embodiments of the present disclosure.

FIG. 9 is a drawing for explaining the touch panel driver of the display device according to one or more embodiments of the present disclosure.

FIG. 10 is a drawing illustrating an example of the touch panel driver in FIG. 9 driving the touch electrodes in the second mode.

FIG. 11 is a drawing illustrating the touch panel driver of a display device according to one or more embodiments of the present disclosure driving the touch electrodes in the second mode.

FIG. 12 is a flowchart illustrating a method for driving a display device according to one or more embodiments of the present disclosure.

FIG. 13 is a block diagram illustrating an electronic device according to one or more embodiments of the present disclosure.

### DETAILED DESCRIPTION

Aspects of some embodiments of the present disclosure and methods of accomplishing the same may be understood more readily by reference to the detailed description of embodiments and the accompanying drawings. The described embodiments are provided as examples so that this disclosure will be thorough and complete, and will fully convey the aspects of the present disclosure to those skilled in the art. Accordingly, processes, elements, and techniques that are redundant, that are unrelated or irrelevant to the description of the embodiments, or that are not necessary to those having ordinary skill in the art for a complete understanding of the aspects of the present disclosure may be omitted. Unless otherwise noted, like reference numerals, characters, or combinations thereof denote like elements throughout the attached drawings and the written description, and thus, repeated descriptions thereof may be omitted.

The described embodiments may have various modifications and may be embodied in different forms, and should not be construed as being limited to only the illustrated embodiments herein. The use of “can,” “may,” or “may not” in describing an embodiment corresponds to one or more embodiments of the present disclosure.

A person of ordinary skill in the art would appreciate, in view of the present disclosure in its entirety, that each suitable feature of the various embodiments of the present disclosure may be combined or combined with each other, partially or entirely, and may be technically interlocked and operated in various suitable ways, and each embodiment may be implemented independently of each other or in conjunction with each other in any suitable manner unless otherwise stated or implied.

In the drawings, the relative sizes of elements, layers, and regions may be exaggerated for clarity and/or descriptive purposes. In other words, because the sizes and thicknesses of elements in the drawings are arbitrarily illustrated for convenience of description, the disclosure is not limited thereto. Additionally, the use of cross-hatching and/or shading in the accompanying drawings is generally provided to clarify boundaries between adjacent elements. As such, neither the presence nor the absence of cross-hatching or shading conveys or indicates any preference or requirement for particular materials, material properties, dimensions, proportions, commonalities between illustrated elements, and/or any other characteristic, attribute, property, etc., of the elements, unless specified.

Various embodiments are described herein with reference to sectional illustrations that are schematic illustrations of embodiments and/or intermediate structures. As such, variations from the shapes of the illustrations as a result of, for example, manufacturing techniques and/or tolerances, are to be expected. Further, specific structural or functional descriptions disclosed herein are merely illustrative for the purpose of describing embodiments according to the concept of the present disclosure. Thus, embodiments disclosed herein should not be construed as limited to the illustrated shapes of elements, layers, or regions, but are to include deviations in shapes that result from, for instance, manufacturing.

Spatially relative terms, such as “beneath,” “below,” “lower,” “lower side,” “under,” “above,” “upper,” “over,” “higher,” “upper side,” “side” (e.g., as in “sidewall”), and the like, may be used herein for ease of explanation to describe one element or feature's relationship to another element(s) or feature(s) as illustrated in the figures. It will be understood that the spatially relative terms are intended to encompass different orientations of the device in use or in operation, in addition to the orientation depicted in the figures. For example, if the device in the figures is turned over, elements described as “below,” “beneath,” “or “under” other elements or features would then be oriented “above” the other elements or features. Thus, the example terms “below” and “under” can encompass both an orientation of above and below. The device may be otherwise oriented (e.g., rotated 90 degrees or at other orientations) and the spatially relative descriptors used herein should be interpreted accordingly. Similarly, when a first part is described as being arranged “on” a second part, this indicates that the first part is arranged at an upper side or a lower side of the second part without the limitation to the upper side thereof on the basis of the gravity direction.

Further, the phrase “in a plan view” means when an object portion is viewed from above, and the phrase “in a schematic cross-sectional view” means when a schematic cross-section taken by vertically cutting an object portion is viewed from the side. The terms “overlap” or “overlapped” mean that a first object may be above or below or to a side of a second object, and vice versa. Additionally, the term “overlap” may include stack, face or facing, extending over, covering, or partly covering or any other suitable term as would be appreciated and understood by those of ordinary skill in the art. The expression “not overlap” may include meaning, such as “apart from” or “set aside from” or “offset from” and any other suitable equivalents as would be appreciated and understood by those of ordinary skill in the art. The terms “face” and “facing” may mean that a first object may directly or indirectly oppose a second object. In a case in which a third object intervenes between a first and second object, the first and second objects may be understood as being indirectly opposed to one another, although still facing each other.

It will be understood that when an element, layer, region, or component is referred to as being “formed on,” “on,” “connected to,” or “(operatively or communicatively) coupled to” another element, layer, region, or component, it can be directly formed on, on, connected to, or coupled to the other element, layer, region, or component, or indirectly formed on, on, connected to, or coupled to the other element, layer, region, or component such that one or more intervening elements, layers, regions, or components may be present. In addition, this may collectively mean a direct or indirect coupling or connection and an integral or non-integral coupling or connection. For example, when a layer, region, or component is referred to as being “electrically connected” or “electrically coupled” to another layer, region, or component, it can be directly electrically connected or coupled to the other layer, region, and/or component or one or more intervening layers, regions, or components may be present. The one or more intervening components may include a switch, a resistor, a capacitor, and/or the like. In describing embodiments, an expression of connection indicates electrical connection unless explicitly described to be direct connection, and “directly connected/directly coupled,” or “directly on,” refers to one component directly connecting or coupling another component, or being on another component, without an intermediate component.

In addition, in the present specification, when a portion of a layer, a film, an area, a plate, or the like is formed on another portion, a forming direction is not limited to an upper direction but includes forming the portion on a side surface or in a lower direction. On the contrary, when a portion of a layer, a film, an area, a plate, or the like is formed “under” another portion, this includes not only a case where the portion is “directly beneath” another portion but also a case where there is further another portion between the portion and another portion. Meanwhile, other expressions describing relationships between components, such as “between,” “immediately between” or “adjacent to” and “directly adjacent to,” may be construed similarly. It will be understood that when an element or layer is referred to as being “between” two elements or layers, it can be the only element or layer between the two elements or layers, or one or more intervening elements or layers may also be present.

For the purposes of this disclosure, expressions such as “at least one of,” or “any one of,” or “one or more of” when preceding a list of elements, modify the entire list of elements and do not modify the individual elements of the list. For example, “at least one of X, Y, and Z,” “at least one of X, Y, or Z,” “at least one selected from the group consisting of X, Y, and Z,” and “at least one selected from the group consisting of X, Y, or Z” may be construed as X only, Y only, Z only, any combination of two or more of X, Y, and Z, such as, for instance, XYZ, XYY, YZ, and ZZ, or any variation thereof. Similarly, the expressions “at least one of A and B” and “at least one of A or B” may include A, B, or A and B. As used herein, “or” generally means “and/or,” and the term “and/or” includes any and all combinations of one or more of the associated listed items. For example, the expression “A and/or B” may include A, B, or A and B. Similarly, expressions such as “at least one of,” “a plurality of,” “one of,” and other prepositional phrases, when preceding a list of elements, modify the entire list of elements and do not modify the individual elements of the list. When “C to D” is stated, it means C or more and D or less, unless otherwise specified.

It will be understood that, although the terms “first,” “second,” “third,” etc., may be used herein to describe various elements, components, regions, layers and/or sections, these elements, components, regions, layers and/or sections should not be limited by these terms. These terms do not correspond to a particular order, position, or superiority, and are used only used to distinguish one element, member, component, region, area, layer, section, or portion from another element, member, component, region, area, layer, section, or portion. Thus, a first element, component, region, layer or section described below could be termed a second element, component, region, layer or section, without departing from the spirit and scope of the present disclosure. The description of an element as a “first” element may not require or imply the presence of a second element or other elements. The terms “first,” “second,” etc. may also be used herein to differentiate different categories or sets of elements. For conciseness, the terms “first,” “second,” etc. may represent “first-category (or first-set),” “second-category (or second-set),” etc., respectively.

In the examples, the x-axis, the y-axis, and/or the z-axis are not limited to three axes of a rectangular coordinate system, and may be interpreted in a broader sense. For example, the x-axis, the y-axis, and the z-axis may be perpendicular to one another, or may represent different directions that are not perpendicular to one another. The same applies for first, second, and/or third directions.

The terminology used herein is for the purpose of describing embodiments only and is not intended to be limiting of the present disclosure. As used herein, the singular forms “a” and “an” are intended to include the plural forms as well, while the plural forms are also intended to include the singular forms, unless the context clearly indicates otherwise. It will be further understood that the terms “comprises,” “comprising,” “have,” “having,” “includes,” and “including,” when used in this specification, specify the presence of the stated features, integers, steps, operations, elements, and/or components, but do not preclude the presence or addition of one or more other features, integers, steps, operations, elements, components, and/or groups thereof.

As used herein, the terms “substantially,” “about,” “approximately,” and similar terms are used as terms of approximation and not as terms of degree, and are intended to account for the inherent deviations in measured or calculated values that would be recognized by those of ordinary skill in the art. For example, “substantially” may include a range of +/−5% of a corresponding value. “About” or “approximately,” as used herein, is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” may mean within one or more standard deviations, or within ±30%, 20%, 10%, 5% of the stated value. Further, the use of “may” when describing embodiments of the present disclosure refers to “one or more embodiments of the present disclosure.”

In some embodiments well-known structures and devices may be described in the accompanying drawings in relation to one or more functional blocks (e.g., block diagrams), units, and/or modules to avoid unnecessarily obscuring various embodiments. Those skilled in the art will understand that such block, unit, and/or module are/is physically implemented by a logic circuit, an individual component, a microprocessor, a hard wire circuit, a memory element, a line connection, and other electronic circuits. This may be formed using a semiconductor-based manufacturing technique or other manufacturing techniques. The block, unit, and/or module implemented by a microprocessor or other similar hardware may be programmed and controlled using software to perform various functions discussed herein, optionally may be driven by firmware and/or software. In addition, each block, unit, and/or module may be implemented by dedicated hardware, or a combination of dedicated hardware that performs some functions and a processor (for example, one or more programmed microprocessors and related circuits) that performs a function different from those of the dedicated hardware. In addition, in some embodiments, the block, unit, and/or module may be physically separated into two or more interact individual blocks, units, and/or modules without departing from the scope of the present disclosure. In addition, in some embodiments, the block, unit and/or module may be physically combined into more complex blocks, units, and/or modules without departing from the scope of the present disclosure.

Unless otherwise defined, all terms (including technical and scientific terms) used herein have the same meaning as commonly understood by one of ordinary skill in the art to which the present disclosure belongs. It will be further understood that terms, such as those defined in commonly used dictionaries, should be interpreted as having a meaning that is consistent with their meaning in the context of the relevant art and/or the present specification, and should not be interpreted in an idealized or overly formal sense, unless expressly so defined herein.

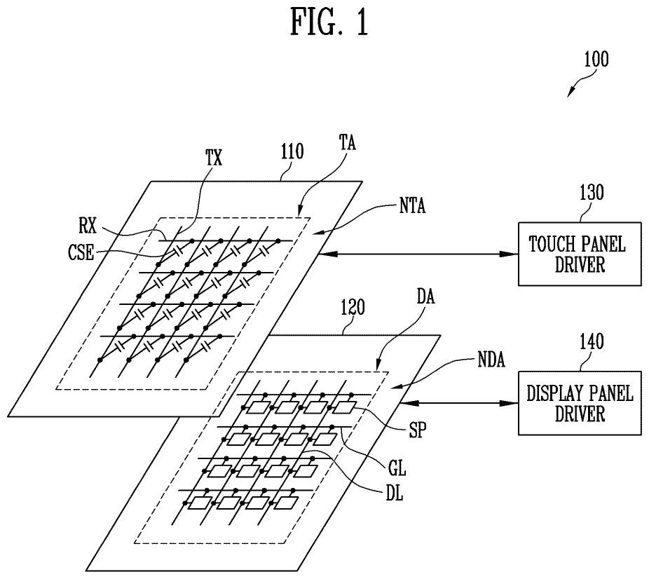

FIG. 1 is a drawing illustrating a display device according to one or more embodiments of the present disclosure.

Referring to FIG. 1, the display device 100 may include a touch panel 110, a display panel 120, a touch panel driver 130, and a display panel driver 140.

In FIG. 1, the touch panel 110 and the display panel 120 are illustrated separately from each other. However, this is only for functionally distinguishing the touch panel 110 and the display panel 120 within the display device 100. For example, the touch panel 110 may be formed in a separate process from the display panel 120, and the touch panel 110 and the display panel 120 may be combined with each other (for example, the touch panel 110 may be attached and combined on one surface of the display panel 120). That is, the touch panel 110 may be formed in an add-on type. In contrast, the touch panel 110 may be formed in a single process (for example, a process for manufacturing the display panel 120) with the display panel 120. That is, the touch panel 110 may be formed in an in-cell type.

The touch panel 110 may be provided on one side of the display panel 120. For example, the touch panel 110 may be located on one side (for example, the upper side) of the two sides of the display panel 120 in the direction in which an image is emitted. In one or more other embodiments, the touch panel 110 may be formed directly on at least one side of the two sides of the display panel 120, or may be formed inside the display panel 120. For example, the touch panel 110 may be formed directly on the outer surface of the upper substrate or the lower substrate of the display panel 120 (that is, the upper surface of the upper substrate or the lower surface of the lower substrate), or may be formed directly on the inner surface of the upper substrate (that is, the lower surface of the upper substrate) or the inner surface of the lower substrate (that is, the upper surface of the lower substrate).

The touch panel 110 may include a touch area TA capable of detecting a touch, and a non-touch area NTA located outside the touch area TA (for example, a peripheral area or edge area of the touch area TA). In one or more embodiments, the touch area TA may be located to correspond to the display area DA of the display panel 120.

In one or more embodiments, the touch panel 110 may be located so that at least one area overlaps the display panel 120. For example, the touch area TA of the touch panel 110 may be arranged on the display area DA of the display panel 120. In one or more embodiments, at least one electrode for detecting a touch may be arranged on the touch area TA. The at least one electrode for detecting a touch may include a first touch electrode TX and a second touch electrode RX. The first touch electrode TX and the second touch electrode RX may be provided on the display area DA of the display panel 120.

In the non-touch area NTA, wirings for electrically connecting at least one electrode provided in the touch area TA to the touch panel driver 130 may be arranged. For example, wirings for electrically connecting the first touch electrode TX and the second touch electrode RX to the touch panel driver 130 may be arranged on the non-touch area NTA. The non-touch area NTA may be located to correspond to the non-display area NDA of the display panel 120.

The touch panel 110 may include at least one first touch electrode TX and a second touch electrode RX provided in the touch area TA. For example, the touch panel 110 may include a first touch electrode TX and a second touch electrode RX crossing the first touch electrode TX. According to one or more embodiments, the first touch electrode TX may extend along a first direction, and the second touch electrode RX may extend along a second direction crossing the first direction while being insulated from the first touch electrode TX by an insulating film, in one or more embodiments. A capacitor CSE is formed between the first touch electrode TX and the second touch electrode RX. The capacitance between the first touch electrode TX and the second touch electrode RX changes when a touch occurs at or around the touch point. Accordingly, the touch panel driver 130 may detect a touch by detecting a change in capacitance (that is, mutual electrostatic capacitance) between the first touch electrode TX and the second touch electrode RX.

However, the present disclosure is not limited to the shape, size, and/or arrangement direction of the first touch electrode TX and the second touch electrode RX.

The display panel 120 includes a display area DA and a non-display area NDA located outside the display area DA (for example, an edge area or a peripheral area of the display area DA).

A gate line GL and a data line DL are arranged in the display area DA, and a sub-pixel SP electrically connected to the gate line GL and to the data line DL is arranged in the display area (DA). Wires for supplying various driving signals and/or power for driving the sub-pixel SP may be provided in the non-display area NDA.

However, the present disclosure is not limited to the type of the display panel 120. For example, the display panel 120 may be a self-luminous display panel. For example, the display panel 120 may include a plurality of light-emitting elements. For example, the light-emitting element may be an organic light-emitting diode. For example, the light-emitting element may be an inorganic light-emitting diode, such as a micro LED (light-emitting diode) or a quantum dot light-emitting diode. For example, the light-emitting element may be a composite element composed of organic and inorganic materials. For example, the display panel 120 may be a non-luminous display panel, such as a liquid crystal display panel (LCD panel), an electro-phoretic display panel (EPD panel), or an electro-wetting display panel (EWD panel). In the case where the display panel 120 is a non-luminous display panel, the display device 100 may further include a backlight unit for supplying light to the display panel 120.

The touch panel driver 130 may be connected to the touch panel 110 to transmit a signal input to the touch panel 110 or to receive a signal output from the touch panel 110. The touch panel driver 130 may supply a touch-driving signal to the touch panel 110, and then may receive a touch-sensing signal corresponding to the touch-driving signal from the touch panel 110 to detect a touch. To this end, the touch panel driver 130 may include a touch-driving-signal output unit and a touch-sensing-signal receiver. In one or more embodiments, the touch-driving-signal output unit and the touch-sensing-signal receiver may be integrated into a single integrated circuit (IC), but the present disclosure is not limited thereto. In one or more embodiments, the touch panel driver 130 (for example, the touch-driving-signal output unit) may supply a touch-driving signal to a plurality of first touch electrodes TX simultaneously (or sequentially). The touch panel driver 130 (for example, the touch-sensing-signal receiver) may receive a touch-sensing signal from the second sensing electrodes RX. The touch panel driver 130 may receive a touch-sensing signal from the touch panel 110, and may perform signal processing on it to detect a touch input and/or the touch coordinates.

The display panel driver 140 is connected to the display panel 120, and may supply a signal input to the display panel 120, or may receive a signal output from the display panel 120. The display panel driver 140 may supply a gate signal to the gate line GL and a data voltage to the data line DL.

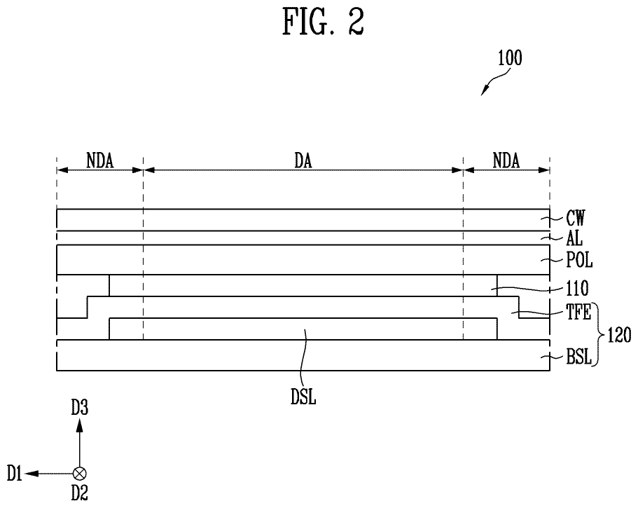

FIG. 2 is a cross-sectional view illustrating an example of the display device in FIG. 1.

Referring to FIG. 2, the display device 100 may include a display panel 120 and a touch panel 110 located on the display panel 120. An anti-reflection layer POL, an adhesive layer AL, and a cover window CW may be located on the touch panel 110 (as used herein, “located on” may mean “above”).

FIG. 2 shows that the display panel 120 is a self-luminous display panel including a light-emitting element. However, the present disclosure is not limited to the type of the display panel 120.

The display panel 120 may include a first base substrate BSL, an element layer DSL, and an encapsulation layer TFE.

The first base substrate BSL may support the element layer DSL. The first base substrate BSL may include an insulating material. Examples of the insulating material may include at least one of glass, quartz, ceramic, or plastic. The first base substrate BSL may be a rigid substrate, and according to one or more embodiments, the first base substrate BSL may be a flexible substrate.

The element layer DSL may be located on the first base substrate BSL (for example, in the third direction D3). The element layer DSL may include a sub-pixel (SP in FIG. 1) and a signal line located on the first base substrate BSL. The sub-pixel may include a thin film transistor TFT and a capacitor. In one or more embodiments, the sub-pixel may include a light-emitting element electrically connected to the thin film transistor and/or the capacitor. The signal line may include a gate line configured to transmit a gate signal to each sub-pixel, and a data line configured to transmit a data voltage. The subpixels included in the element layer DSL may be located within the display area DA. A common electrode (for example, a cathode electrode of a light-emitting element, a common electrode of a liquid crystal display device, or the like) may be formed on the element layer DSL.

An encapsulation layer TFE may be located on the element layer DSL. The encapsulation layer TFE may protect the element layer DSL from external moisture and/or oxygen. The encapsulation layer TFE may include two or more thin film layers formed on the element layer DSL. For example, the encapsulation layer TFE may include an inorganic thin film layer formed on the element layer DSL, an organic thin film layer formed on the inorganic thin film layer, and an inorganic thin film layer located on the organic thin film layer. In one or more embodiments, the encapsulation layer TFE may be formed of a glass substrate and cover the element layer DSL. The encapsulation layer TFE may cover the element layer DSL in the display area DA and the non-display area NDA.

The touch panel 110 may be located on the encapsulation layer TFE. In one or more embodiments, the touch panel 110 may be formed directly on the encapsulation layer TFE. In one or more embodiments, the touch panel 110 may be formed through a separate process from the display panel 120, and may be located on (for example, attached to) the encapsulation layer TFE. The touch panel 110 may have a touch area (TA in FIG. 1) in at least some of the areas overlapping the display area DA. The touch panel 110 may have a non-touch area (NTA in FIG. 1) in at least some of the areas overlapping the non-display area NDA.

The anti-reflection layer POL may be located on the touch panel 110. The anti-reflection layer POL may reduce the reflectivity of external light incident on the touch panel 110 and the display panel 120. In one or more embodiments, the anti-reflection layer POL may include a polarizing film. The polarizing film may include a phase retarder and/or a polarizer. For example, the polarizing film may be an iodine-based polarizing film.

The cover window CW may be located on the touch panel 110. The cover window CW may protect the display panel 120 and the touch panel 110 from external impact and the like. The cover window CW may be implemented as a film made of a light-transmitting (for example, transparent) material, such as glass and/or plastic.

In one or more embodiments, the display device 100 may further include one or more optical layers (for example, an anti-glare layer, a polarizing plate, a color filter, a liquid crystal, or the like).

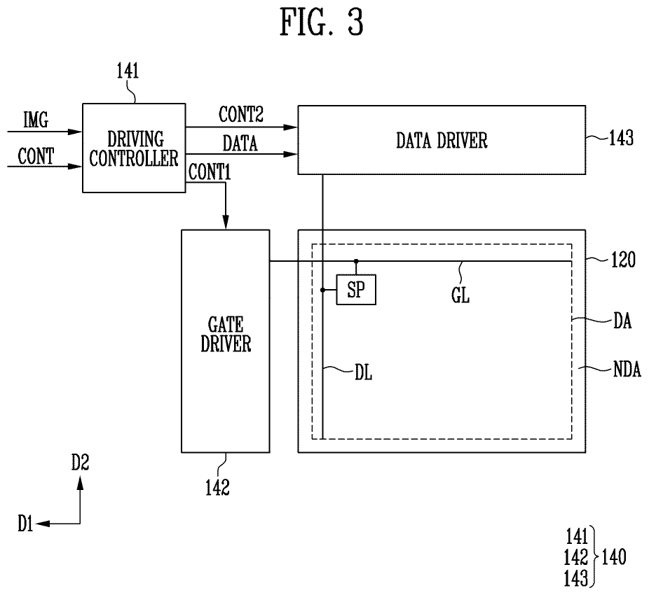

FIG. 3 is a block diagram illustrating an example of the display panel and the display panel driver in FIG. 1.

Referring to FIG. 3, the display device may include the display panel 120 and the display panel driver 140. The display panel driver 140 may include a driving controller 141, a gate driver 142, and a data driver 143. In one or more embodiments, the driving controller 141 and the data driver 143 may be integrated into a single chip.

The display panel 120 may include a display area DA that displays an image, and a non-display area NDA arranged adjacent to the display area DA. In one or more embodiments, the gate driver 142 may be mounted in the non-display area NDA.

The display panel 120 may include a plurality of gate lines GL, a plurality of data lines DL, and a plurality of sub-pixels SP electrically connected to the gate lines GL and the data lines DL. The gate lines GL may extend in a first direction D1, and the data lines DL may extend in a second direction D2 crossing the first direction D1.

The driving controller 141 may receive input image data IMG and an input control signal CONT from a main processor (for example, a graphics-processing unit (GPU) or the like). For example, the input image data IMG may include red image data, green image data, and blue image data. In one or more embodiments, the input image data IMG may further include white image data. As another example, the input image data IMG may include magenta image data, yellow image data, and cyan image data. The input control signal CONT may include a master clock signal and a data enable signal. The input control signal CONT may further include a vertical synchronization signal and a horizontal synchronization signal.

The driving controller 141 may generate a first control signal CONT1, a second control signal CONT2, and a data signal DATA based on the input image data IMG and the input control signal CONT.

The driving controller 141 may generate a first control signal CONT1 for controlling the operation of the gate driver 142 based on the input control signal CONT, and may output it to the gate driver 142. The first control signal CONT1 may include a vertical start signal and a gate clock signal.

The driving controller 141 may generate a second control signal CONT2 for controlling the operation of the data driver 143 based on the input control signal CONT, and may output it to the data driver 143. The second control signal CONT2 may include a horizontal start signal and a load signal.

The driving controller 141 may receive the input image data IMG and the input control signal CONT to generate a data signal DATA. The driving controller 141 may output the data signal DATA to the data driver 143.

The gate driver 142 may generate gate signals for driving the gate lines GL in response to the first control signal CONT1 received from the driving controller 141. The gate driver 142 may output the gate signals to the gate lines GL. For example, the gate driver 142 may sequentially output gate signals to the gate lines GL.

The data driver 143 may receive a second control signal CONT2 and a data signal DATA from the driving controller 141. The data driver 143 may generate data voltages by converting the data signal DATA into analog voltages. The data driver 143 may output the data voltages to the data line DL.

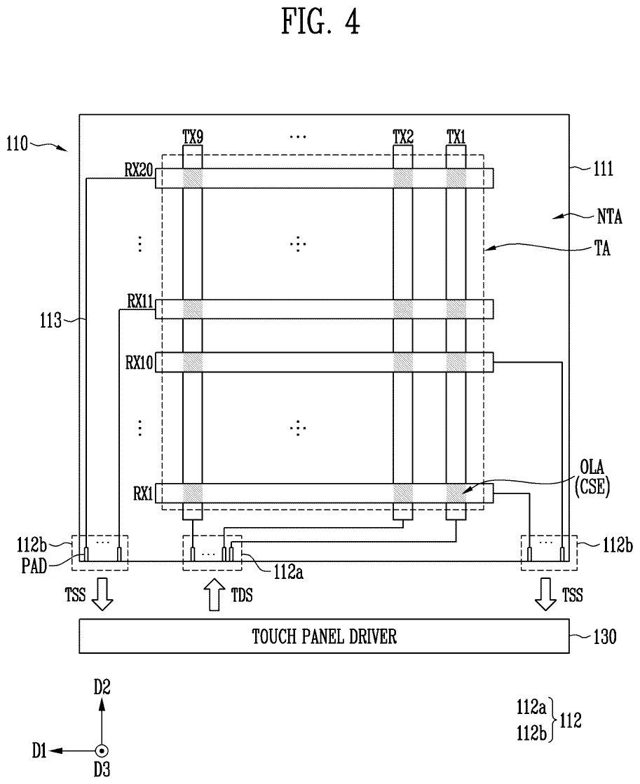

FIG. 4 is a block diagram illustrating an example of the touch panel in FIG. 1.

Referring to FIG. 4, the touch panel 110 may include a second base substrate 111, first touch electrodes TX1 to TX9, second touch electrodes RX1 to RX20, a pad portion 112, and wiring 113.

The second base substrate 111 is a substrate that serves as a substrate for the touch panel 110, and may be a rigid or flexible substrate. For example, the second base substrate 111 may be a rigid substrate including glass or tempered glass, or a flexible substrate including a thin film of a flexible plastic material. The first touch electrodes TX1 to TX9, the second touch electrodes RX1 to RX20, the pad portions 112, the wiring 113, and the like may be arranged on the second base substrate 111. In one or more embodiments, the second base substrate 111 may be omitted (or replaced with a different configuration). For example, when the first touch electrodes TX1 to TX9 and the second touch electrodes RX1 to RX20 are formed directly on the display panel (120 in FIG. 1), the second base substrate 111 may be replaced with the first base substrate (BSL in FIG. 2) or the encapsulation layer (TFE in FIG. 2) described above.

The first touch electrodes TX1 to TX9 may extend in the second direction D2. For example, each of the first touch electrodes TX1 to TX9 may be arranged to extend in the column direction in the touch panel 110.

The second touch electrodes RX1 to RX20 may extend along the first direction D1. For example, each of the second touch electrodes RX1 to RX20 may be arranged to extend in the row direction in the touch panel 110.

The touch panel 110 may be driven by a mutual capacitance method. In the mutual capacitance method, one of the first touch electrodes TX1 to TX9 or the second touch electrodes RX1 to RX20 may function as a touch-driving electrode, and the other may function as a touch-sensing electrode. A touch-driving signal TDS is input to the touch-driving electrode, and a touch-sensing signal TSS is output from the touch-sensing electrode. In one or more embodiments, the first touch electrodes TX1 to TX9 may receive a touch-driving signal TDS for touch-driving, and the second touch electrodes RX1 to RX20 may output a touch-sensing signal TSS corresponding to the touch-driving signal FDS. In one or more embodiments, the second touch electrodes RX1 to RX20 may receive a touch-driving signal TDS, and the first touch electrodes TX1 to TX9 may output a touch-sensing signal TSS corresponding to the touch-driving signal TDS. For convenience of explanation, the following description will be given as an example where the touch-driving signal TDS is input to the first touch electrodes TX1 to TX9 and the second touch electrodes RX1 to RX20 output a touch-sensing signal TSS, but the present disclosure is not limited thereto.

A capacitor CSE may be formed between the first touch electrodes TX1 to TX9 and the second touch electrodes RX1 to RX20. The first touch electrodes TX1 to TX9 and the second touch electrodes RX1 to RX20 may be arranged to overlap each other in a vertical direction (for example, a third direction D3) in an overlapping area OLA. In the overlapping area OLA, the first touch electrodes TX1 to TX9 may function as one electrode of the capacitor CSE, and the second touch electrodes RX1 to RX20 may function as the other electrode of the capacitor CSE. The capacitor CSE may be formed between the first touch electrodes TX1 to TX9 and the second touch electrodes RX1 to RX20 in the overlapping area OLA. When an object (for example, a human finger or the like) approaches the touch panel 110, the capacitance between the first touch electrode TX and the second touch electrode RX may change. The touch panel driver (130 in FIG. 1) may detect a touch input and/or the touch coordinates based on the changed capacitance.

The pad portion 112 may include one or more pads PAD. The pad PAD may connect the first touch electrodes TX1 to TX9 and the second touch electrodes RX1 to RX20 to the touch panel driver (130 in FIG. 1). For example, a touch-driving signal TDS may be input to the first touch electrodes TX1 to TX9 through the first pad portion 112a. For example, a touch-sensing signal TSS may be output from the second touch electrodes RX1 to RX20 through the second pad portion 112b.

The wiring 113 may electrically connect the pad PAD and the first touch electrodes TX1 to TX9 or electrically connect the pad PAD and the second touch electrodes RX1 to RX20.

The pad portion 112 and the wiring 113 may be located in the non-touch area NTA.

In one or more embodiments, the number of first touch electrodes TX1 to TX9 may be 9 and the number of second touch electrodes RX1 to RX20 may be 20, but the present disclosure is not limited to the numbers of first touch electrodes TX1 to TX9 or second touch electrodes RX1 to RX20.

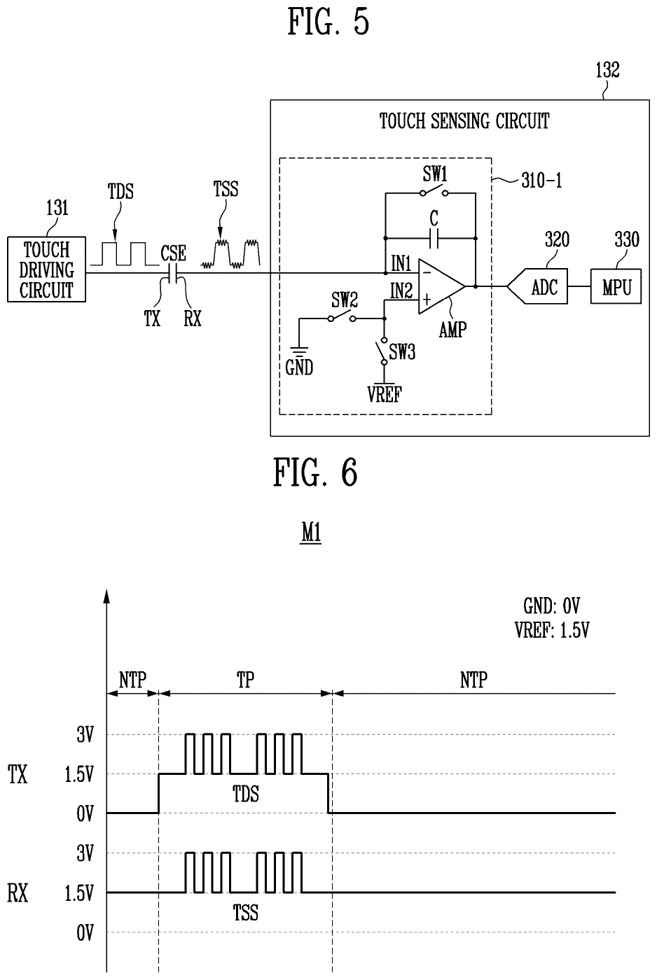

FIG. 5 is a drawing for explaining the touch panel driver in FIG. 1.

Referring to FIG. 1 and FIG. 5, the touch panel driver 130 may include the touch-driving circuit 131 and the touch-sensing circuit 132.

The touch-driving circuit 131 may generate a touch-driving signal TDS. The touch-driving signal TDS may be implemented as a square wave, but according to one or more embodiments, the touch-driving signal TDS may be implemented as a sine wave. The touch-driving signal TDS may be input to the first touch electrode TX.

A capacitor CSE may be formed by the first touch electrode TX and the second touch electrode RX. A touch-sensing signal TSS corresponding to the touch-driving signal TDS may be output to the second touch electrode RX by the touch-driving signal TDS supplied to the first touch electrode TX. The touch-sensing signal TSS may be input to the touch-sensing circuit 132. The touch-sensing circuit 132 may amplify, convert, and process the touch-sensing signal TSS input from the second touch electrode RX. The touch-sensing circuit 132 may detect a touch input and/or the touch coordinates based on the signal-processing result.

The touch-sensing circuit 132 may include a signal receiver (e.g., signal-receiving unit) 310-1, an analog-to-digital converter 320 (ADC), and a signal processor (e.g., a signal-processing unit) 330.

The signal receiver 310-1 may receive a touch-sensing signal TSS from the second touch electrode RX. The signal receiver 310-1 may amplify and output the touch-sensing signal TSS. For example, the signal receiver 310-1 may be implemented as an analog front end (AFE) including an operational amplifier OP-Amp.

The signal receiver 310-1 may be connected to the second touch electrode RX. The signal receiver 310-1 may include an amplifier AMP including a first input terminal IN1, a second input terminal IN2, and an output terminal connected to a second touch electrode RX, a first switch SW1 including a first terminal connected to the first input terminal IN1 of the amplifier AMP and a second terminal connected to the output terminal of the amplifier AMP, and a capacitor C including a first electrode connected to the first input terminal IN1 of the amplifier AMP and a second electrode connected to the output terminal of the amplifier AMP, and one of a ground voltage GND or a reference voltage VREF may be selectively applied to the second input terminal IN2 of the amplifier AMP. For example, the signal receiver 310-1 may include a second switch SW2 including a first terminal connected to the second input terminal IN2 of the amplifier AMP and a second terminal connected to a ground voltage GND (for example, voltage of the ground terminal) and a third switch SW3 including a first terminal connected to the second input terminal IN2 of the amplifier AMP and a second terminal for receiving a reference voltage VREF.

The analog-to-digital converter 320 may convert an analog signal input from the signal receiver 310-1 into a digital signal. According to one or more embodiments, the analog-to-digital converter 320 may be provided in the number of second touch electrodes RX so as to correspond to the touch channels corresponding to the second touch electrodes RX in one-to-one correspondence. According to one or more embodiments, the analog-to-digital converter 320 may be configured so that a plurality of second touch electrodes RX share one analog-to-digital converter 320. In this case, a switching circuit (for example, a w multiplexer) may be provided between the signal receiver 310-1 and the analog-to-digital converter 320.

The signal processor 330 may perform signal processing on the signal (digital signal) converted by the analog-to-digital converter 320, and may detect a touch input and/or the touch coordinates based on the signal-processing result. For example, the signal processor 330 may comprehensively analyze a signal (for example, an amplified and converted touch-sensing signal TSS) input from the plurality of first touch electrodes TX through the signal receiver 310-1 and the analog-to-digital converter 320 to detect a touch input and its location. According to one or more embodiments, the signal processor 330 may be implemented as a microprocessor unit (MPU). In this case, a memory used for driving the signal processor 330 may be additionally provided inside the touch-sensing circuit 132. However, the configuration of the signal processor 330 is not limited thereto. As another example, the signal processor 330 may be implemented as a microcontroller unit (MCU) or the like.

In one or more embodiments, the first to third switches SW1 to SW3 may be controlled by the signal processor 330. In one or more other embodiments, the first to third switches SW1 to SW3 may be controlled through a separate controller within the touch panel driver 130.

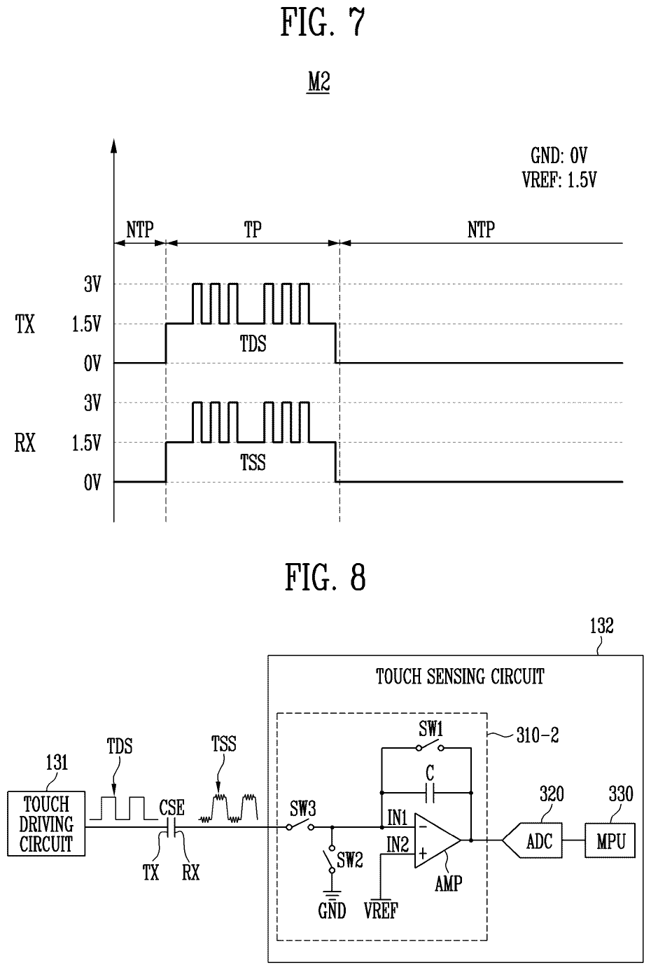

FIG. 6 is a timing diagram illustrating an example of the touch panel driver in FIG. 5 driving the touch electrodes in the first mode, and FIG. 7 is a timing diagram illustrating an example of the touch panel driver in FIG. 5 driving the touch electrodes in the second mode.

Referring to FIGS. 4 to 7, one frame may include a touch section TP that detects a touch, and a non-touch section NTP that does not detect a touch. For example, in the touch section TP, the touch-driving circuit 131 may apply a touch-driving signal TDS to the first touch electrode TX, and the touch-sensing circuit 132 may receive a touch-sensing signal TSS from the second touch electrode RX.

The touch panel driver 130 may initially operate in the first mode M1. The touch panel driver 130 may operate in the second mode M2 when the amount of change in capacitance between the first touch electrodes TX and the second touch electrodes RX is equal to or greater than the reference amount of change. That is, the touch panel driver 130 may operate in the first mode M1 when the amount of change in capacitance between the first touch electrodes TX and the second touch electrodes RX is less than the reference amount of change.

For example, the amount of change in capacitance between the first touch electrodes TX and the second touch electrodes RX may be an average value or a total sum of the amounts of change in capacitance in each of the capacitors CSE. For example, the amounts of change in capacitance in each of the capacitors CSE may be calculated through signals from the second touch electrodes RX. For example, the reference amount of change may be a preset value.

Referring to FIG. 2 and FIGS. 4 to 7, when different voltages are applied between the first touch electrode TX and the second touch electrode RX, an electric field may be formed between the first touch electrode TX and the second touch electrode RX. In this case, especially in a high temperature and/or high humidity environment, ions of a layer other than the touch panel 110 may react with the touch electrodes TX and RX, causing the touch electrodes TX and RX to corrode. For example, the anti-reflection layer POL includes an iodine-based polarizing film and iodine ions of the iodine-based polarizing film may react with the touch electrodes TX and RX. In addition, as the touch electrodes TX and RX corrode, the capacitance between the first touch electrodes TX and the second touch electrodes RX may change. Accordingly, in the non-touch section NTP of the second mode M2, the touch panel driver 130 may apply the same voltage to the second touch electrodes RX as applied to the first touch electrodes TX. This will be described in detail below.

Referring to FIG. 5 and FIG. 6, the touch panel driver 130 may apply a ground voltage GND to the first touch electrodes TX in the non-touch section NTP of the first mode M1, may apply a touch-driving signal TDS to the first touch electrodes TX in the touch section TP of the first mode M1, and may apply a reference voltage VREF to the second touch electrodes RX in the first mode M1. For example, in the first mode M1, the second switch SW2 may be turned off, and the third switch SW 3 may be turned on. In addition, in the first mode M1, the reference voltage VREF may be applied to the second input terminal IN2 of the amplifier AMP, and the reference voltage VREF may be applied to the first input terminal IN 1 of the amplifier AMP.

In the touch section TP of the first mode M1, a reference voltage VREF may be applied to the second touch electrodes RX, and the signal of the second touch electrodes RX may be changed by an amount corresponding to the touch-driving signal TDS at the reference voltage VREF.

Referring to FIG. 5 and FIG. 7, the touch panel driver 130 may apply a ground voltage GND to the first touch electrodes TX in the non-touch section NTP of the second mode M2, may apply a touch-driving signal TDS to the first touch electrodes TX in the touch section TP of the second mode M2, may apply a ground voltage GND to the second touch electrodes RX in the non-touch section NTP of the second mode M2, and may apply a reference voltage VREF to the second touch electrodes RX in the touch section TP of the second mode M2.

For example, in the non-touch section NTP of the second mode M2, the second switch SW2 may be turned on, and the third switch SW 3 may be turned off. In the non-touch section NTP of the second mode M2, a ground voltage GND may be applied to the second input terminal IN2 of the amplifier AMP, and a ground voltage GND may be applied to the first input terminal IN1 of the amplifier AMP.

For example, in the touch section TP of the second mode M2, the second switch SW2 may be turned off, and the third switch SW3 may be turned on. In the touch section TP of the second mode M2, a reference voltage VREF may be applied to the second input terminal IN2 of the amplifier AMP, and a reference voltage VREF may be applied to the first input terminal IN 1 of the amplifier AMP.

In the non-touch section NTP of the second mode M2, the ground voltage GND may be applied to the second touch electrodes RX in the same manner as the first touch electrodes TX, thereby reducing or preventing the likelihood of the generation of an electric field between the first touch electrodes TX and the second touch electrodes RX, and thus reducing or preventing corrosion of the touch electrodes TX and RX.

In the touch section TP of the second mode M2, the reference voltage VREF may be applied to the second touch electrodes RX, and the signal of the second touch electrodes RX may be changed by an amount corresponding to the touch-driving signal TDS at the reference voltage VREF.

FIG. 8 is a drawing for explaining a touch panel driver of a display device according to one or more embodiments of the present disclosure.

The touch panel driver (130 in FIG. 4) according to the present embodiments is substantially the same as the touch panel driver 130 in FIG. 5 except for the signal receiver 310-2. Thus, the same reference numbers and reference symbols are used for the same or similar components, and redundant descriptions are omitted.

Referring to FIG. 8, the signal receiver 310-2 may include an amplifier AMP including a first input terminal IN1, a second input terminal IN2, and an output terminal connected to a second touch electrode RX or configured to receive a ground voltage GND, a first switch SW1 including a first terminal connected to the first input terminal IN1 of the amplifier AMP and a second terminal connected to the output terminal of the amplifier AMP, and a capacitor C including a first electrode connected to the first input terminal IN1 of the amplifier AMP and a second electrode connected to the output terminal of the amplifier AMP. For example, the signal receiver 310-2 may include a second switch SW2 including a first terminal connected to a first input terminal IN1 of the amplifier AMP and a second terminal connected to a ground voltage GND, and a third switch SW 3 including a first terminal connected to a second touch electrode RX and a second terminal connected to the first input terminal IN1 of the amplifier AMP.

Referring to FIG. 6 and FIG. 8, in the first mode M1, the second switch SW2 may be turned off, and the third switch SW 3 may be turned on. In addition, in the first mode M1, a reference voltage VREF may be applied to the second input terminal IN2 of the amplifier AMP, and the reference voltage VREF may be applied to the first input terminal IN1 of the amplifier AMP.

Referring to FIG. 7 and FIG. 8, in the non-touch section NTP of the second mode M2, the second switch SW2 may be turned on, and the third switch SW3 may be turned off. In addition, in the non-touch section NTP of the second mode M2, a ground voltage GND may be applied to the first input terminal IN1 of the amplifier AMP.

In the non-touch section NTP of the second mode M2, the ground voltage GND may be applied to the second touch electrodes RX in the same manner as the first touch electrodes TX, thereby reducing or preventing the likelihood of an electric field from being generated between the first touch electrodes TX and the second touch electrodes RX, and thus reducing or preventing corrosion of the touch electrodes TX and RX.

In the touch section TP of the second mode M2, the second switch SW2 may be turned off, and the third switch SW3 may be turned on. In the touch section TP of the second mode M2, the reference voltage VREF may be applied to the second input terminal IN2 of the amplifier AMP, and the reference voltage VREF may be applied to the first input terminal IN1 of the amplifier AMP.

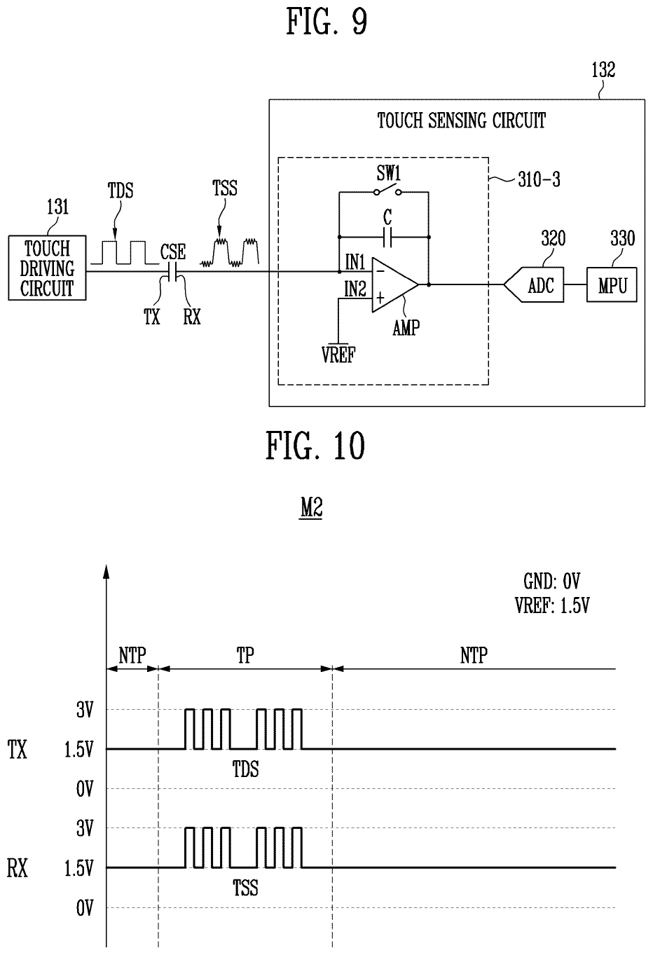

FIG. 9 is a drawing for explaining a touch panel driver of a display device according to one or more embodiments of the present disclosure, and FIG. 10 is a drawing illustrating an example of the touch panel driver in FIG. 9 driving the touch electrodes in the second mode.

The touch panel driver (130 in FIG. 4) according to the present embodiments is substantially the same as the configuration of the touch panel driver 130 in FIG. 5, except for the signal receiver 310-3. Thus, the same reference numbers and reference symbols are used for the same or similar components, and redundant descriptions are omitted.

The operation of the touch panel driver (130 in FIG. 4) according to the present embodiments in the first mode is substantially the same as the operation described with reference to FIG. 7. Thus, redundant descriptions are omitted.

Referring to FIG. 9, the signal receiver 310-3 may include an amplifier AMP including a first input terminal IN1 connected to a second touch electrode RX, a second input terminal IN2 for receiving a reference voltage VREF, and an output terminal, a first switch SW1 including a first terminal connected to the first input terminal IN1 of the amplifier AMP and a second terminal connected to the output terminal of the amplifier AMP, and a capacitor C including a first electrode connected to the first input terminal IN1 of the amplifier AMP and a second electrode connected to the output terminal of the amplifier AMP.

Referring to FIG. 9 and FIG. 10, in the non-touch section NTP of the second mode M2, the touch panel driver (130 in FIG. 4) may apply a reference voltage VREF to the second touch electrodes RX, and may apply a reference voltage VREF to the first touch electrodes TX.

By applying the reference voltage VREF to the first touch electrodes TX in the non-touch section NTP of the second mode M2 as well as to the second touch electrodes RX, the likelihood of an electric field being generated between the first touch electrodes TX and the second touch electrodes RX may be reduced or prevented, and thus, corrosion of the touch electrodes TX and RX may be reduced or prevented.

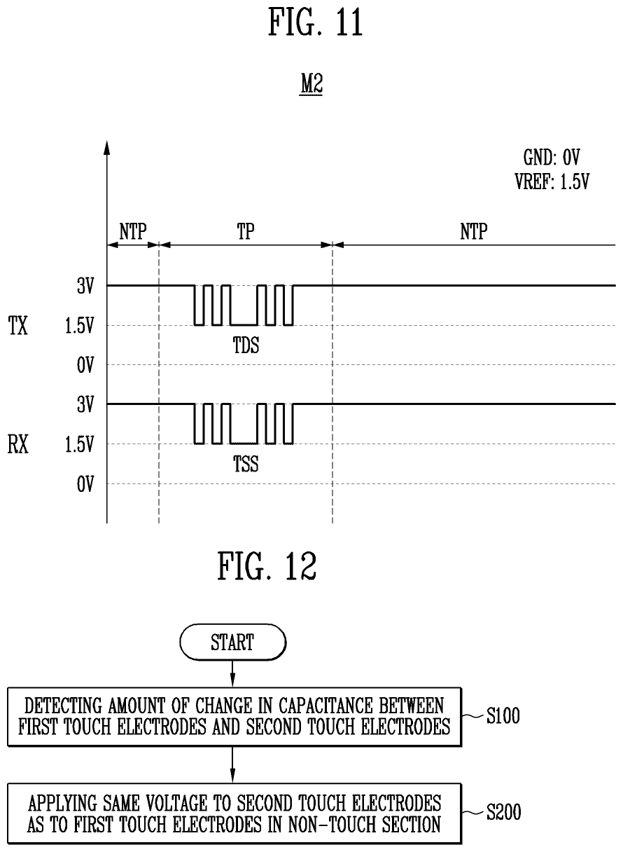

FIG. 11 is a drawing illustrating that a touch panel driver of a display device according to one or more embodiments of the present disclosure drives touch electrodes in a second mode.

The operation in the second mode M2 according to the present embodiments is substantially the same as the operation in the second mode M2 in FIG. 10, except that a voltage different from the reference voltage (VREF in FIG. 9) is used in the non-touch section NTP, so that redundant descriptions are omitted.

Referring to FIG. 11, the touch panel driver (130 in FIG. 4) may apply a voltage (for example, about 3 V) to the first touch electrodes TX and the second touch electrodes RX in the non-touch section NTP of the second mode M2. The present disclosure is not limited to the method of applying the arbitrary voltage.

By applying the same voltage to the first touch electrodes TX and the second touch electrodes RX in the non-touch section NTP of the second mode M2, the likelihood of the generation of an electric field between the first touch electrodes TX and the second touch electrodes RX may be reduced or prevented, and thus, corrosion of the touch electrodes TX and RX may be reduced or prevented.

FIG. 12 is a flowchart illustrating a method for driving a display device according to one or more embodiments of the present disclosure.

Referring to FIG. 12, the method for driving a display device may detect a change in capacitance between the first touch electrodes and the second touch electrodes (S100), and if the amount of change in capacitance is equal to or greater than a reference amount of change, the method for driving a display device may apply the same voltage to the second touch electrodes as to the first touch electrodes in the non-touch section (S200). However, because this has been described with reference to FIGS. 1 to 11, redundant descriptions thereof will be omitted.

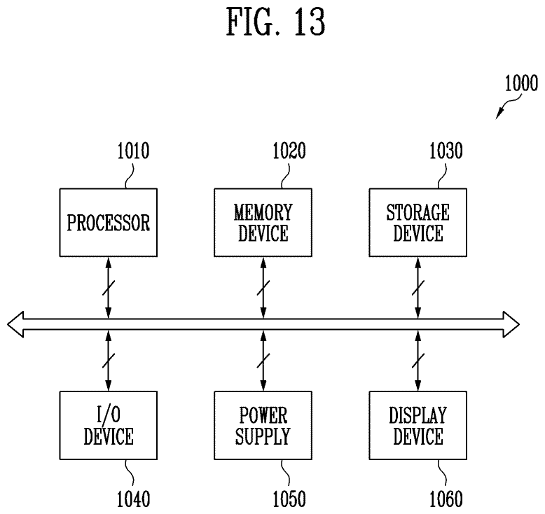

FIG. 13 is a block diagram illustrating an electronic device according to one or more embodiments of the present disclosure.

Referring to FIG. 13, an electronic device 1000 may include a processor 1010, a memory device 1020, a storage device 1030, an input/output device 1040, a power supply 1050, and a display device 1060. At this time, the display device 1060 may be the display device in FIG. 1. In addition, the electronic device 1000 may further include several ports that can communicate with a video card, a sound card, a memory card, a USB device, and the like, or can communicate with other systems. In one or more embodiments, the electronic device 1000 may be implemented as a smartphone. However, this is an example, and the electronic device 1000 is not limited thereto. For example, the electronic device 1000 may be implemented as a mobile phone, a television, a video phone, a smart pad, a smartwatch, a tablet PC, a car navigation system, a computer monitor, a laptop, a head-mounted display device, and the like.

The processor 1010 may perform specific calculations or tasks. According to one or more embodiments, the processor 1010 may be a microprocessor, a central processing unit, an application processor, and the like. The processor 1010 may be connected to other components through an address bus, a control bus, a data bus, and the like. According to one or more embodiments, the processor 1010 may also be connected to an expansion bus, such as a peripheral component interconnect (PCI) bus.

The memory device 1020 may store data necessary for the operation of the electronic device 1000. For example, the memory device 1020 may include a nonvolatile memory device, such as an erasable programmable read-only memory (EPROM) device, an electrically erasable programmable read-only memory (EEPROM) device, a flash memory device, a phase change random access memory (PRAM) device, a resistance random access memory (RRAM) device, a nano-floating gate memory (NFGM) device, a polymer random access memory (PoRAM) device, a magnetic random access memory (MRAM), a ferroelectric random access memory (FRAM) device, and/or a volatile memory device, such as a dynamic random access memory (DRAM) device, a static random access memory (SRAM) device, a mobile DRAM device, and the like.

The storage device 1030 may include a solid-state drive (SSD), a hard disk drive (HDD), a CD-ROM, and the like.

The input/output device 1040 may include input means, such as a keyboard, a keypad, a touchpad, a touchscreen, a mouse, and the like, and output means, such as a speaker, a printer, and the like. According to one or more embodiments, the display device 1060 may be included in the input/output device 1040.

The power supply 1050 may supply the power required for the operation of the electronic device 1000. For example, the power supply 1050 may be a power management integrated circuit (PMIC).

The display device 1060 may display an image corresponding to the visual information of the electronic device 1000. At this time, the display device 1060 may be an organic light-emitting display device or a quantum dot light-emitting display device but is not limited thereto. The display device 1060 may be connected to other components via the above buses or other communication links.

The present disclosure may be applied to a display device and to an electronic device including the same. For example, the present disclosure may be applied to digital TVs, 3D TVs, mobile phones, smartphones, tablet computers, VR devices, PCs, home electronic devices, notebook computers, PDAs, PMPs, digital cameras, music players, portable game consoles, navigation devices, and the like.

Although embodiments and application examples have been described herein, they are provided only to help a more general understanding of the present disclosure, and the present disclosure is not limited to the above embodiments, and various modifications and variations are possible from this description by those with common knowledge in the field to which the present disclosure pertains.

Therefore, the spirit of the present disclosure should not be limited to the described embodiments, and all things that are equivalent or have equivalent modifications to the following claims as well as the claims are considered to fall within the scope of the spirit of the present disclosure. Further, although the present disclosure has been described with reference to the above embodiments, it will be understood by those skilled in the art that various modifications, and changes may be made to the embodiments without departing from the spirit and scope of the present disclosure as set forth in the claims below, with functional equivalents thereof to be included therein.

What is claimed is:

1. A display device comprising:
a touch panel comprising first touch electrodes arranged in a first direction, and second touch electrodes arranged in a second direction crossing the first direction; and
a touch panel driver configured to provide touch-driving signals to the first touch electrodes, and to receive touch-sensing signals corresponding to the touch-driving signals from the second touch electrodes,
wherein the second touch electrodes and the first touch electrodes are configured to receive a same voltage in a non-touch section.

2. The display device of claim 1, wherein the touch panel driver is configured to operate in a first mode when an amount of change in capacitance between the first touch electrodes and the second touch electrodes is less than a reference amount of change, to operate in a second mode when the amount of the change in the capacitance is equal to or greater than the reference amount of the change, and to apply the same voltage to the second touch electrodes and to the first touch electrodes in the non-touch section of the second mode.

3. The display device of claim 2, wherein the touch panel driver is configured to apply a reference voltage to the second touch electrodes in the touch section of the second mode and in the first mode.

4. The display device of claim 3, wherein the first touch electrodes are configured to receive a ground voltage in the non-touch section.

5. The display device of claim 4, wherein the touch panel driver comprises a signal receiver, the signal receiver comprising:
an amplifier comprising a first input terminal, a second input terminal, and an output terminal connected to at least one of the second touch electrodes;
a first switch comprising a first terminal connected to the first input terminal of the amplifier, and a second terminal connected to the output terminal of the amplifier; and
a capacitor comprising a first electrode connected to the first input terminal of the amplifier, and a second electrode connected to the output terminal of the amplifier, and
wherein the second input terminal of the amplifier is configured to selectively receive one of the ground voltage or the reference voltage.

6. The display device of claim 5, wherein the touch panel driver is configured to apply the ground voltage to the second input terminal of the amplifier in the non-touch section of the second mode, and to apply the reference voltage to the second input terminal of the amplifier in the touch section of the second mode and in the first mode.

7. The display device of claim 4, wherein the touch panel driver comprises a signal receiver, the signal receiver comprising:
an amplifier comprising a first input terminal, a second input terminal, and an output terminal connected to at least one of the second touch electrodes, or configured to receive the ground voltage;
a first switch comprising a first terminal connected to the first input terminal of the amplifier, and a second terminal connected to the output terminal of the amplifier; and
a capacitor comprising a first electrode connected to the first input terminal of the amplifier, and a second electrode connected to the output terminal of the amplifier.

8. The display device of claim 7, wherein the touch panel driver is configured to apply the ground voltage to the first input terminal of the amplifier in the non-touch section of the second mode, and to connect the first input terminal of the amplifier to the at least one of the second touch electrodes in the touch section of the second mode and in the first mode.

9. The display device of claim 2, wherein the touch panel driver is configured to apply a reference voltage to the second touch electrodes and to the first touch electrodes in the non-touch section of the second mode.

10. A method for driving a display device, comprising:
detecting an amount of change in capacitance between first touch electrodes and second touch electrodes; and
applying a same voltage to the second touch electrodes and to the first touch electrodes in a non-touch section when the amount of the change in the capacitance is equal to or greater than a reference amount of change.

11. The method for driving the display device of claim 10, further comprising:
applying a reference voltage to the second touch electrodes in the touch section when the amount of the change in the capacitance is equal to or greater than the reference amount of the change; and
applying the reference voltage to the second touch electrodes when the amount of the change in the capacitance is less than the reference amount of the change.

12. The method for driving the display device of claim 11, further comprising applying a ground voltage to the first touch electrodes in the non-touch section.

13. The method for driving the display device of claim 12, wherein at least one of the second touch electrodes is connected to a signal receiver, the signal receiver comprising:
an amplifier comprising a first input terminal, a second input terminal, and an output terminal connected to the at least one of the second touch electrodes;
a first switch comprising a first terminal connected to the first input terminal of the amplifier, and a second terminal connected to the output terminal of the amplifier; and
a capacitor comprising a first electrode connected to the first input terminal of the amplifier, and a second electrode connected to the output terminal of the amplifier, and
wherein the method further comprises selectively applying one of the ground voltage or the reference voltage to the second input terminal of the amplifier.

14. The method for driving the display device of claim 13, further comprising:
applying the ground voltage to the second input terminal of the amplifier in the non-touch section when the amount of the change of the capacitance is equal to or greater than the reference amount of the change,
applying the reference voltage to the second input terminal of the amplifier in the touch section when the amount of the change of the capacitance is equal to or greater than the reference amount of the change, and
applying the reference voltage to the second input terminal of the amplifier when the amount of the change of the capacitance is less than the reference amount of the change.

15. The method for driving the display device of claim 12, wherein at least one of the second touch electrodes is connected to a signal receiver, the signal receiver comprising:
an amplifier comprising a first input terminal, a second input terminal, and an output terminal connected to the at least one of the second touch electrodes, or configured to receive the ground voltage;
a first switch comprising a first terminal connected to the first input terminal of the amplifier, and a second terminal connected to the output terminal of the amplifier; and
a capacitor comprising a first electrode connected to the first input terminal of the amplifier, and a second electrode connected to the output terminal of the amplifier.

16. The method for driving the display device of claim 15, further comprising:
applying the ground voltage to the first input terminal of the amplifier in the non-touch section, and connecting the first input terminal of the amplifier to the at least one of the second touch electrodes, in the touch section when the amount of the change in the capacitance is equal to or greater than the reference amount of the change, and
connecting the first input terminal of the amplifier to the at least one of the second touch electrodes in the touch section when the amount of the change in the capacitance is less than the reference amount of the change.

17. The method for driving the display device of claim 10, further comprising:
applying a reference voltage to the second touch electrodes; and
applying the reference voltage to the first touch electrodes in the non-touch section when the amount of the change in the capacitance is equal to or greater than the reference amount of the change.

18. An electronic device comprising:
a processor to provide input image data; and
a display device to display an image based on the input image data,
the display device comprising:
a touch panel comprising first touch electrodes arranged in a first direction, and second touch electrodes arranged in a second direction crossing the first direction; and
a touch panel driver configured to provide touch-driving signals to the first touch electrodes, and to receive touch-sensing signals corresponding to the touch-driving signals from the second touch electrodes,
wherein the second touch electrodes and the first touch electrodes are configured to receive a same voltage in a non-touch section.
